(19) United States
(12) Patent Application Publication
(10) Pub. No.: US 2024/0296778 A1
(43) Pub. Date: Sep. 5, 2024

(54) DISPLAY PANEL, DISPLAY DEVICE AND DRIVING METHOD

(71) Applicants: BEIJING BOE DISPLAY TECHNOLOGY CO., LTD., Beijing (CN); BOE TECHNOLOGY GROUP CO., LTD., Beijing (CN)

(72) Inventor: Zhaoyun Gu, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 18/027,110

(22) PCT Filed: Apr. 29, 2022
(86) PCT No.: PCT/CN2022/090308

§ 371 Date: Mar. 19, 2023

(51) Int. Cl. G09G 3/20

(52) U.S. Cl. CPC G09G 3/2096; G09G 2300/0413; G09G 2300/0452; G09G 2310/0275; G09G 2310/0297

(57) ABSTRACT

This application relates to a display panel, including a plurality of pixel islands. Each of the pixel islands includes M pixel units and N time-division multiplexing circuits, where M and N are both positive integers greater than 1. Each of the time-division multiplexing circuits includes m switching transistors configured to drive the M pixel units, where m<M, and the relationship between m and M is non-multiple. The M pixel units include a dummy pixel unit, and the N time-division multiplexing circuits include a first time-division multiplexing circuit. The first time-division multiplexing circuit includes a dummy switching transistor correspondingly connected to the dummy pixel unit. This application also relates to a display device and a driving method.

### TECHNICAL FIELD

The present disclosure relates to the technical field of manufacturing display products, particularly to a display panel, a display device and a driving method.

### BACKGROUND

The pixel island design needs to use more Sources, as it has more sub-pixels than the conventional RGB arrangement. The MUX (multiplexer) design can effectively reduce the number of Source as used. However, when the number of the MUX channels is not a multiple of the number of Views (viewpoints) contained in a pixel island, a plurality of MUX combinations need to be used to achieve the compatibility of 2D/3D display, so that a MUX circuit will not cross two pixel islands, such as MUX 1:2 and MUX 1:1. When different control signals are turned on, the corresponding data amounts are inconsistent, and the difficulty of FPGA or TCON data processing is increased.

### SUMMARY

In order to solve the above-mentioned technical problems, the present disclosure provides a display panel, a display device, and a driving method, which solve the problem that data processing difficulty is increased due to different MUX combinations.

In order to achieve the above objective, embodiments of the present disclosure adopt the following technical solutions: a display panel including a plurality of pixel islands, where each of the pixel islands includes M pixel units and N time-division multiplexing circuits, where each of M and N is a positive integer greater than 1. Each of the time-division multiplexing circuits includes m switching transistors configured to drive the M pixel units, where m<M, and a relationship between m and M is non-multiple. The M pixel units include a dummy pixel unit, and the N time-division multiplexing circuits include a first time-division multiplexing circuit, where the first time-division multiplexing circuit includes a dummy switching transistor correspondingly connected to the dummy pixel unit.

Optionally, gate electrodes of the m switching transistors in each of the time-division multiplexing circuits are connected to different control signal lines, the m switching transistors are labeled as labels 1 to m according to a preset rule, and gate electrodes of switching transistors having the same label in different time-division multiplexing circuits are connected to a same control signal line.

Optionally, first electrodes of the m switching transistors in a same one of the time-division multiplexing circuits are connected to a same one of data lines of a data driving circuit.

Optionally, the m switching transistors are respectively connected to m control signal lines, where one of the data lines of the data driving circuit provides a data signal to an m-th switching transistor connected to an m-th control signal line when the m-th control signal line is turned on.

Optionally, in the first time-division multiplexing circuit, the m-th switching transistor is the dummy switching transistor, and the m-th control signal line provides a dummy start signal to the dummy switching transistor, to enable a corresponding one of the data lines to provide a dummy data signal.

Optionally, the pixel island includes two pixel groups being an odd-numbered pixel group and an even-numbered pixel group, the odd-numbered pixel group includes odd-numbered columns of pixel units, and the even-numbered pixel group includes even-numbered columns of pixel units. The time-division multiplexing circuit include a first switching transistor and a second switching transistor, the first switching transistor is connected to an odd-numbered column of pixel units, and the second switching transistor is connected to an even-numbered column of pixel units adjacent to the odd-numbered column of pixel units.

Optionally, the display panel further includes a data driving circuit, the data driving circuit includes a plurality of data lines, and each of the data lines is used to provide a data signal to the m switching transistors in the time-division multiplexing circuit.

Optionally, in each of the time-division multiplexing circuits, the first switching transistor is configured to receive a first data signal, and the second switching transistor is configured to receive a second data signal. The plurality of pixel islands includes a first pixel island and a second pixel island adjacent to each other, a pixel unit adjacent to the first pixel island and the second pixel island is the dummy pixel unit, and a data signal received by a pixel unit in the first pixel island adjacent to the dummy pixel unit is the first data signal. A data signal received by a pixel unit in the second pixel island adjacent to the dummy pixel unit is the second data signal.

Optionally, each of the pixel units includes a red sub-pixel, a green sub-pixel and a blue sub-pixel.

An embodiment of the present disclosure also provides a display device, including the display panel as described above. The display panel is connected to a first circuit board through a chip on film technique, the first circuit board is connected to a second circuit board through a flexible circuit board, and the second circuit board is provided with a display interface.

An embodiment of the present disclosure also provides a driving method applied to the display device as described above, including:
providing a first control signal through a first control signal line, and controlling a switching transistor at a first position in the N time-division multiplexing circuits to be turned on to transmit a data signal to a corresponding one of the pixel units; and
providing a second control signal through a second control signal line, and controlling a switching transistor at a second position in the N time-division multiplexing circuits to be turned on to transmit a data signal to a corresponding one of the pixel units, where the dummy switching transistor in the first time-division multiplexing circuit is configured to receive a dummy data signal.

Optionally, the display panel includes a first pixel island and a second pixel island adjacent to each other, each of the time-division multiplexing circuits includes two switching transistors, and the driving method includes:
providing the first control signal through the first control signal line, receiving a first data signal by a first switching transistor in the N time-division multiplexing circuits in the first pixel island, and receiving a second data signal by a third switching transistor in the N time-division multiplexing circuits in the second pixel island, where the first switching transistor is connected to one of the pixel units away from the second pixel island in a first direction, the third switching transistor is connected to one of the pixel units close to the first pixel island in the first direction, and the first direction is parallel to a row direction of the pixel units; and
providing the second control signal through the second control signal line, receiving the second data signal by a second switching transistor in the N time-division multiplexing circuits in the first pixel island, and receiving the first data signal by a fourth switching transistor in the N time-division multiplexing circuits in the second pixel island, where the second switching transistor is connected to one of the pixel units close to the second pixel island in the first direction, and the fourth switching transistor is connected to one of the pixel units away from the first pixel island in the first direction; where the dummy switching transistor in the first time-division multiplexing circuit corresponding to the first pixel island is configured to receive the dummy data signal, and a dummy switching transistor in the first time-division multiplexing circuit corresponding to the second pixel island is configured to receive the dummy data signal.

The present disclosure has the beneficial effects that when the MUX circuits with different structures are combined, the data amounts controlled by different control signals are the same based on the setting of the dummy switching transistor, so that the data-driven transmission rate is met, and the data processing difficulty is reduced.

### BRIEF DESCRIPTION OF THE DRAWINGS

FIG. 1 shows a schematic diagram of a time-division multiplexing circuit in the related art;

FIG. 2 shows a schematic diagram of a corresponding relationship between an input of DP module and a pixel unit in the related art:

FIG. 3 shows a schematic diagram of the time-division multiplexing circuit in an embodiment of the present disclosure:

FIG. 4 shows a schematic diagram of the corresponding relationship between the input of DP module and the pixel unit in an embodiment of the present disclosure;

FIG. 5 shows a schematic diagram of a data output format in an embodiment of the present disclosure;

FIG. 6 shows a waveform diagram of a data signal provided by a V1line pattern data line in an embodiment of the present disclosure:

FIG. 7 shows a schematic structural diagram of a display device in an embodiment of the present disclosure; and

FIG. 8 shows a schematic diagram of a signal transmission path in an embodiment of the present disclosure.

### DETAILED DESCRIPTION

In order to make the objective, technical solution and advantages of embodiments of the present disclosure clearer, the technical scheme of the embodiments of the present disclosure will be described clearly and completely in conjunction with the appended drawings. Obviously, the described embodiments are a part of the embodiments of the present disclosure, not the whole embodiments. Based on the described embodiments of the present disclosure, all other embodiments obtained by those skilled in the art fall within the protection scope of the present disclosure.

In the description of the present disclosure, it should be noted that the orientation or positional relationship indicated by terms such as “center”, “upper”, “lower”, “left”, “right”, “vertical”, “horizontal”, “inside” and “outside” are based on those shown in the drawings, which are only for the convenience of describing the present disclosure and simplifying the description, and do not indicate or imply that the referred devices or elements must have a specific orientation, be constructed and operated in a specific orientation, so it cannot be understood as limiting the present disclosure. In addition, terms such as “first”, “second” and “third” are only used for descriptive purposes and cannot be understood as indicating or implying relative importance.

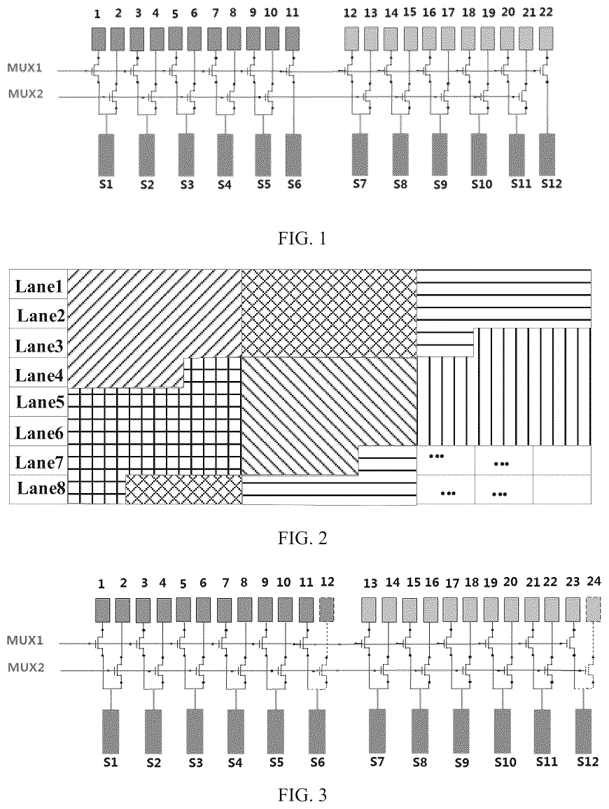

Referring to FIG. 1 and FIG. 2, when the number of Views (viewpoints) within one pixel island is not a multiple of the MUX (time-division multiplexing) channels (i.e. the number of switching transistors), in order to ensure 2D display, the existing pixel island is designed as a combination of two or more MUXs so that the MUX circuit does not cross two pixel islands. As shown in FIG. 1, one pixel island contains 11 Views, and uses a combination of MUX 1:2 and MUX 1:1; and such a structure has the following problems.

Using MUX combinations with different structures greatly increases the difficulty of data processing in FPGA (Field Programmable Gate Array) or TCON (Timing Control). An example is given that DP (display interface) interface acts as a system input, data is usually 24 bit/Lane, and data of each pixel unit is 8 bit, then each Lane transmits data of 3 sub-pixels. 1Lane/2Lane/4Lane are selected automatically according to different amounts of transmitted data. Assuming that 2Lane is selected, and it will become 8Lane through “2 to 8” modules. The 8Lane can transmit data of 24 sub-pixels in total, but one pixel island only contains eleven-numbered pixel units (1 pixel unit contains 3 sub-pixels), as shown in FIG. 1, the corresponding relationship between the data outputted by the DP module and the pixel island is complex. Referring to FIG. 2, in the Lane4 in FIG. 2, data of pixel units P10 and P11 in one pixel island is transmitted; data of a pixel unit P1 in another pixel island is also transmitted (it should be noted that Lane transmits 3 sub-pixel data at a time, that is, an Lane4 transmits data of one sub-pixel in a pixel unit P10, data of one sub-pixel in a pixel unit P11 and data of one sub-pixel in a pixel unit P1). Twenty-two pixel islands are taken as a period, minimum period data needs to be buffered during subsequent data processing, which has a large amount of buffered data and occupies a lot of resources.

The data output rule is that: when MUX1 is turned on, all data of MUX1 in a row are output in sequence, and when MUX2 is turned on, and data of MUX2 in a row are output in sequence. The transmission rate of Source Driver is limited, so it usually selects an output at a fixed rate, which requires the same amount of data to be transmitted when MUX1 and MUX2 are turned on, but at present, the amount of data in MUX1 in a row is far more than that in MUX2.

In order to solve the above problems, an embodiment provides a display panel, including a plurality of pixel islands. Each of the pixel islands includes M pixel units and N time-division multiplexing circuits, M and N are both positive integers greater than 1.

Each of the time-division multiplexing circuits includes m switching transistors configured to drive the M pixel units, where m<M, and a relationship between m and M is non-multiple.

The M pixel units include a dummy pixel unit, the N time-division multiplexing circuits include a first time-division multiplexing circuit, and the first time-division multiplexing circuit includes a dummy switching transistor correspondingly connected to the dummy pixel unit.

The dummy pixel unit is connected to the dummy switching transistor and receives a corresponding dummy signal, so that the data amounts transmitted by the data driving circuit are consistent under different control signals, thereby satisfying the requirement on data driving transmission rate.

Referring to FIG. 3, due to the existence of the dummy pixel unit P12 and the corresponding dummy switching transistor, under the control of the time-division multiplexing circuit, data signals are provided to the pixel units P1, P3, P5, P7, P9 and P11 when the control signal line of MUX1 is turned on, and data signals are provided to the pixel units P2, P4, P6, P8, P10 and P12 when the control signal line of MUX2 is turned on (the dummy data signal is provided to P12). Therefore, within 1H (one cycle), the amount of data outputted by the data driving circuit when the control signal line of MUX1 is turned on is consistent with the amount of data outputted by the data driving circuit when the control signal line of MUX2 is turned on, which will not affect the data push-out caused by that the transmission rate of Source Driver is not reached.

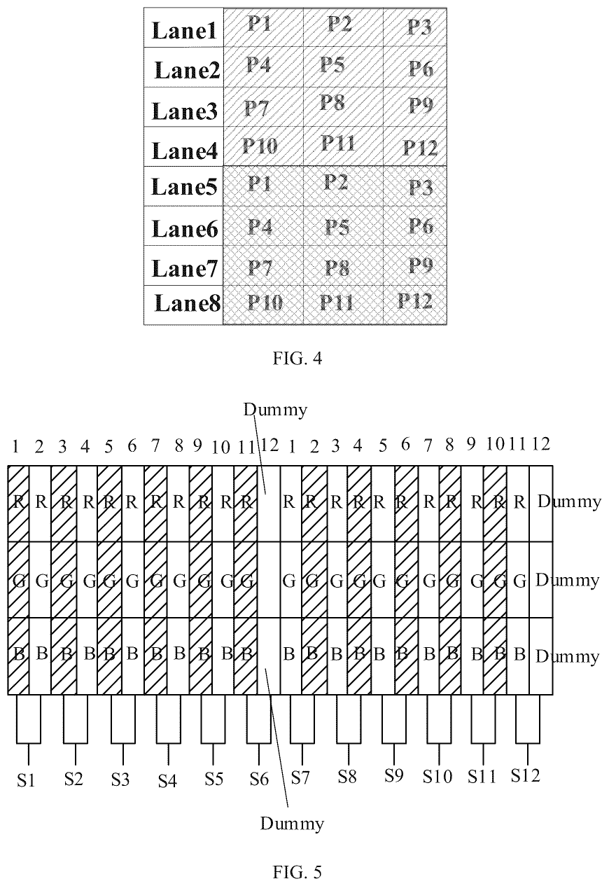

It should be noted that in FIG. 3, in order to facilitate the distinguishing of two pixel islands, the pixel units in one pixel island are labeled as 1 to 12, and the pixel units in the other pixel island are labeled as 13 to 24; in FIG. 4, the pixel units in each pixel island are labeled as 1 to 12; the difference only lies in the labeling forms.

It should be noted that the meaning in FIG. 4 refers to a sub-pixel in the corresponding pixel unit. For example, Lane1 transmits data to a sub-pixel in pixel unit P1, a sub-pixel in pixel unit P2, and a sub-pixel in pixel unit P3. Each pixel unit includes a red sub-pixel, a green sub-pixel, and a blue sub-pixel. Under the control of a corresponding control signal, a corresponding sub-pixel receives a data signal, that is, under the control of dual control signals, it transmits the data signal to the corresponding sub-pixel in the corresponding pixel unit.

Illustratively, gate electrodes of the m switching transistors in each of the time-division multiplexing circuits are connected to different control signal lines, the m switching transistors are labeled as labels 1 to m according to a preset rule, and gate electrodes of switching transistors having the same label in different time-division multiplexing circuits are connected to a same control signal line.

Each time-division multiplexing circuit includes m switching transistors, which are turned on under the control of different control signals, so as to provide data signals to different pixel units and realize the time-division multiplexing function. For example, in FIG. 3, each time-division multiplexing circuit includes two switching transistors, which are connected to two pixel units correspondingly, and the two switching transistors are turned on in different times under the control of different control signals, so that the data driving circuit selectively provides data signals to different pixel units.

The positions of switching transistors controlled by the same control signal in different time-division multiplexing circuits can be the same or different, which can be set according to actual needs.

Illustratively, first electrodes of the m switching transistors in the same time-division multiplexing circuit are connected to a same data line of a data driving circuit.

By adopting the above scheme, the data driving circuit can respond to different control signals to provide data signals to different pixel units. For example, each time-division multiplexing circuit in FIG. 3 includes two switching transistors, and the data driving circuit can provide data signals to different switching transistors in response to different control signals.

Illustratively, the m switching transistors are respectively connected to m control signal lines, wherein a data line of the data driving circuit provides a data signal to an m-th switching transistor connected to an m-th control signal line when the m-th control signal line is turned on.

Illustratively, in the first time-division multiplexing circuit, the m-th switching transistor is the dummy switching transistor, and the m-th control signal line is used to provide a dummy start signal to the dummy switching transistor to enable a corresponding data line to provide a dummy data signal.

Illustratively, the pixel island comprises two pixel groups being an odd-numbered pixel group and an even-numbered pixel group, the odd-numbered pixel group comprises odd-numbered columns of pixel units, and the even-numbered pixel group comprises even-numbered columns of pixel units. When m=2 (that is, when the time-division multiplexing circuit includes two switching transistors), each of the time-division multiplexing circuits comprises a first switching transistor and a second switching transistor, the first switching transistor is connected to an odd-numbered column of pixel units, and the second switching transistor is connected to an even-numbered column of pixel units adjacent to the odd-numbered column of pixel units.

Illustratively, the display panel further includes a data driving circuit, the data driving circuit comprises a plurality of data lines, and each of the data lines is used to provide a data signal to the m switching transistors in the time-division multiplexing circuit.

Illustratively, in each of the time-division multiplexing circuits, the first switching transistor is configured to receive a first data signal, and the second switching transistor is configured to receive a second data signal: the plurality of pixel islands comprises a first pixel island and a second pixel island adjacent to each other, a pixel unit adjacent to the first pixel island and the second pixel island is the dummy pixel unit, and a data signal received by a pixel unit in the first pixel island adjacent to the dummy pixel unit is the first data signal; and a data signal received by a pixel unit in the second pixel island adjacent to the dummy pixel unit is the second data signal.

Illustratively, each of the pixel units includes a red sub-pixel, a green sub-pixel, and a blue sub-pixel.

For example, each Lane transmits 3 sub-pixel data. Referring to FIG. 3, each pixel island includes a plurality of pixel units, each pixel unit includes a plurality of sub-pixels, such as red sub-pixel R, green sub-pixel G, and blue sub-pixel B. The red sub-pixels in a plurality of pixel units are arranged in rows and controlled by the same control signal (named as red control signal), the green sub-pixels in a plurality of pixel units are arranged in rows and controlled by the same control signal (named as green control signal), and the blue sub-pixels in a plurality of pixel units are arranged in rows and controlled by the same control signal (named as blue control signal). For example, under the control of the control signal MUX1 and the red control signal, the data lines S1 to S6 provide data signals to the red sub-pixels in P1, P3, P5, P7, P9 and P11, and under the control of the control signal MUX1 and the green control signal, the data lines S1 to S6 provide data signals to the green sub-pixels in P1, P3, P5, P7, P9 and P11. Under the control of the control signal MUX1 and the blue control signal, the data lines S1 to S6 provide data signals to the blue sub-pixels in P1, P3, P5, P7, P9 and P11.

It should be noted that the pixel island design needs to use more Sources, as it has more sub-pixels than the conventional RGB arrangement. The MUX (time-division multiplexing) design can effectively reduce the number of Source as used. However, when a frame rate is constant, the more the number of MUXs is, the less the charging time of Pixel will be. Considering a case of undercharging, this example takes the design of MUX 1:2 as an example.

The number of View contained in a Pixel island is related not only to the size of Pixel, but also to the number of Lens. In order to eliminate moire effect, the current optical scheme requires that the number of Lens is not a common divisor of and the number of sub-pixels, that is, 2D pixel units (1 pixel island) cannot have repeated units. If a scheme of 1 pixel island corresponding to 2 Lenses is adopted, the number of viewpoints in the pixel island cannot be 10, otherwise, View1 to View5 correspond to one lens and View6 to View 10 correspond to one lens, which will lead to different viewpoints corresponding to different lenses located in the same position, for example, View1 and View6 have the same relative positions with the corresponding lenses, so the moire pattern cannot be eliminated. Therefore, in the embodiment, an example is given that one pixel island corresponds to two lenses, and one pixel island contains eleven Views, but it is not limited to this.

A pixel island includes eleven pixel units (corresponding to 11 viewpoints), and each time-division multiplexing circuit includes two switching transistors. First electrodes of the two switching transistors are connected to a same data line, and the switching transistors in the same position in different time-division multiplexing circuits are turned on at the same time under the control of the same control signal. Specifically, two pixel islands are taken as examples, the first pixel island includes pixel units P1-P12. P12 is a dummy pixel unit, and 6 time-division multiplexing circuits are arranged to be connected to the pixel units in sequence to provide data signals to the pixel units through data lines S1-S6, where S6 corresponds to P11 and P12. Under the control of the control signal MUX1, data lines S1-S6 provide data signals to P1, P3, P5, P7, P9 and P11. Under the control of control signal MUX2, data lines S1-S6 provide data signals to P2, P4, P6, P8, P10 and P12, where S6 provides a dummy data signal to P12, which can enable the data amount when MUX1 is turned on to be consistent with the data amount when MUX2 is turned on, and meet the requirement on the data-driven transmission rate.

Similar to the first pixel island, the second pixel island includes twelve pixel units P13-P24. P24 is a dummy pixel unit, and 6 time-division multiplexing circuits are arranged to be connected to the pixel units in sequence to provide data signals to the pixel units through data lines S7-S12, where S12 corresponds to P23 and P24. Under the control of the control signal MUX1, data lines S7-S12 provide data signals to P13, P15, P17, P19, P21 and P23. Under the control of control signal MUX2, data lines S7-S12 provide data signals to P14, P16, P18, P20, P22 and P24, where S12 provides a dummy data signal to P24, which can enable the data amount when MUX1 is turned on to be consistent with the data amount when MUX2 is turned on, and meet the data-driven transmission rate requirements.

When a DP/HDMI interface is used as a system input, the data is usually 24 bit/Lane, and data in each sub-pixel is 8 bit, so each Lane transmits 3 sub-pixel data, and 2Lane is selected. After passing through the “2-to-8” module, the DP outputs 8Lane. (the transmission of a larger bandwidth is realized through the “2-to-8” module, but it is not limited to this, for example, it can be converted into 16Lane. With the same bandwidth, increasing the number of Lanes can also reduce the main frequency and make it more stable.) 8Lane is able to transmit 24 data in total. The data outputted by the DP module is buffered by the Buffer, and then Data mapping is performed after the minimum period data is buffered. Data mapping reorganizes the 8Lane data and distributes it to each COF. For example, there are 8 COFs and each COF has 8Lane, then Data mapping processes the data into a 64Lane high-speed signal and sends it to each COF. A chip on the COF converts a high-speed signal into a voltage signal required by the Panel. The first pixel island includes twelve pixel units P1 to P12, and the second pixel island includes 12 pixel units P13 to P24. By adopting the technical scheme of the embodiments, the corresponding relationship between transmission data of Lane and pixel units (sub-pixels in pixel units) is simplified. Lane1 to Lane4 correspond to pixel units P1 to P12, and Lane5 to Lane8 correspond to pixel units P13 to P24, referring to FIG. 4 (it should be noted that Lane transmits data of sub-pixels, for example, Lane1 transmits data of a sub-pixel in pixel unit P1, data of a sub-pixel in pixel unit P2, and data of a sub-pixel in pixel unit P3). In Data mapping, it is necessary to find a periodicity rule, and buffer the data in a period to ensure that each data can be transmitted to the corresponding View: With the above solution, the minimum period is two pixel islands of data, and FPGA does not need to add too many invalid data, which can effectively save FPGA resources.

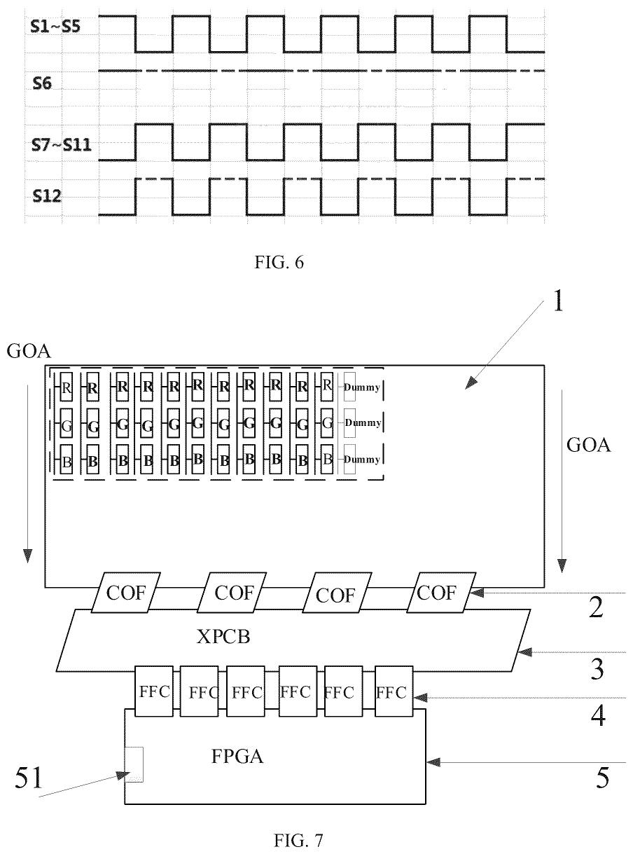

A V1line Pattern is taken as an example, as shown in FIG. 5, that is, one column is bright and one column is dark. It should be noted that since P12 is a dummy pixel unit, the pixel unit P13 of the second pixel island should be dark, and the Source output is repeated in a unit of two pixel islands. The waveform of Source output is shown in FIG. 6, and the output waveforms of S1-S5 are the same, all of which are alternately bright and dark (L255→L0→L255→L0). In the pixel units P11 and P12 corresponding to S6, only P11 is valid data, and the pixel unit P12 is provided with dummy data. Assuming that the Dummy data is L255, the S6 waveform remains L255. Similarly, S7-S11 waveforms are the same, and alternate between dark and bright (L0 →L255→L0→L255). S12 is similar to S6, but the data corresponding to P11 is L0, so the waveform alternate between dark and bright when the Dummy data provided is L255. Dummy data is marked with dotted lines in FIG. 6.

Referring to FIG. 7, an embodiment of the present disclosure also provides a display device, including the display panel 1 as described above. The display panel 1 is connected to a first circuit board 3 through a chip on film (COF) 2, the first circuit board 3 is connected to a second circuit board 5 through a flexible circuit board 4, and the second circuit board 5 is provided with a display interface 51.

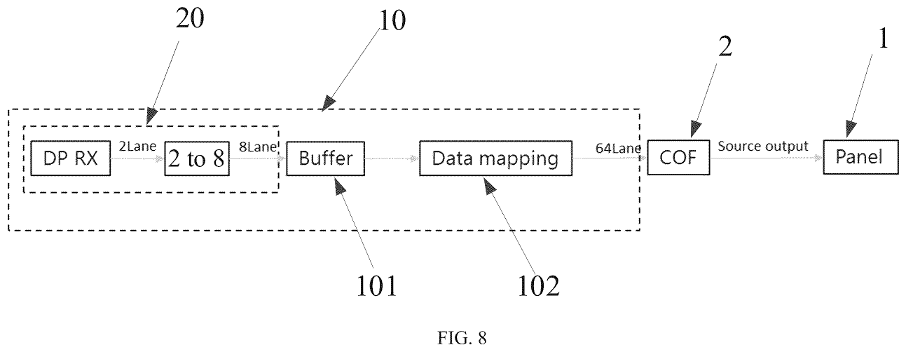

The second circuit board is provided with an FPGA module 10, which is integrated with a DP module 20. The FPGA module 10 further includes a Buffer module 101 and a data processing module (Date mapping) 102. FIG. 8 shows a transmission path of a processed signal, and data inputted from the DP interface (display interface 51) in 2Lane is converted into 8Lane through a 2-to-8 module. The data outputted by the DP module 20 is buffered by the Buffer, and then Data mapping is performed after the minimum period data is buffered. Data mapping reorganizes the 8Lane data and distributes it to each COF. For example, there are 8 COFs and each COF has 8Lane, then Data mapping processes the data into a 64Lane high-speed signal and sends it to each COF. The chip on the COF converts the high-speed signal into a voltage signal required by the Panel.

The display device may be any product or component with a display function, such as liquid crystal display television, liquid crystal display, digital photo frame, mobile phone, tablet computer, etc. The display device further includes a flexible printed circuit board, a printed circuit board, and a back plate.

An embodiment of the present disclosure also provides a driving method applied to the display device as described above, including:
providing a first control signal through a first control signal line, and controlling a switching transistor at a first position in the N time-division multiplexing circuits to be turned on to transmit a data signal to a corresponding one of the pixel units; and
providing a second control signal through a second control signal line, and controlling a switching transistor at a second position in the N time-division multiplexing circuits to be turned on to transmit a data signal to a corresponding one of the pixel units, wherein the dummy switching transistor in the first time-division multiplexing circuit is configured to receive a dummy data signal.

The display panel includes at least a first pixel island and a second pixel island adjacent to each other, and each of the time-division multiplexing circuits includes at least two switching transistors. In an embodiment, the display panel includes a first pixel island and a second pixel island adjacent to each other, and each of the time-division multiplexing circuits includes two switching transistors. Data signals received by the two switching transistors are different, and information displayed by corresponding pixel units are different, for example, an arrangement mode of V1line pattern (pixel units are designed alternately to be light in one column with and to be dark in another column) is adopted. Referring to FIG. 5, the driving method includes:
providing the first control signal through the first control signal line, and receiving a first data signal by a first switching transistor in the N time-division multiplexing circuits in the first pixel island (e.g. a pixel unit P1 corresponding to S1 shown as dark in FIG. 5), and receiving a second data signal by a third switching transistor in the N time-division multiplexing circuits in the second pixel island (e.g. a pixel unit P1 corresponding to S7 shown as dark in FIG. 5), where the first switching transistor is connected to a pixel unit away from the second pixel island in a first direction, and the third switching transistor is connected to a pixel unit close to the first pixel island in the first direction, and the first direction is parallel to a row direction of the pixel units; and
providing the second control signal through the second control signal line, receiving the second data signal by a second switching transistor in N time-division multiplexing circuits in the first pixel island (referring to a pixel unit P2 corresponding to S1 shown as dark in FIG. 5), and receiving the first data signal by a fourth switching transistor in N time-division multiplexing circuits in the second pixel island (referring to a pixel unit P2 corresponding to S7 shown as bright in FIG. 5), where the second switching transistor is connected to a pixel unit close to the second pixel island in the first direction, and the fourth switching transistor is connected to a pixel unit away from the first pixel island in the first direction: where a dummy switching transistor in the first time-division multiplexing circuit corresponding to the first pixel island receives a dummy data signal (referring to a dummy pixel unit P12 corresponding to S6 in FIG. 5), and a dummy switching transistor in the first time-division multiplexing circuit corresponding to the second pixel island receives a dummy data signal (referring to a dummy pixel unit P12 corresponding to S12 in FIG. 5).

It can be understood that the above embodiments are only exemplary embodiments for explaining the principles of the present disclosure, but the present disclosure is not limited thereto. It is obvious to those skilled in the art that various modifications and improvements can be made without departing from the spirit and essence of the present disclosure, and these modifications and improvements shall fall within the protection scope of the present disclosure.

1. A display panel, comprising a plurality of pixel islands, wherein each of the pixel islands comprises M pixel units and N time-division multiplexing circuits, wherein each of M and N is a positive integer greater than 1;
each of the time-division multiplexing circuits comprises m switching transistors configured to drive the M pixel units, wherein m<M, and a relationship between m and M is non-multiple; and
the M pixel units comprise a dummy pixel unit, and the N time-division multiplexing circuits comprise a first time-division multiplexing circuit, wherein the first time-division multiplexing circuit comprises a dummy switching transistor correspondingly connected to the dummy pixel unit.

2. The display panel according to claim 1, wherein gate electrodes of the m switching transistors in each of the time-division multiplexing circuits are connected to different control signal lines, the m switching transistors are labeled as labels 1 to m according to a preset rule, and gate electrodes of switching transistors having the same label in different time-division multiplexing circuits are connected to a same control signal line.

3. The display panel according to claim 2, wherein first electrodes of the m switching transistors in a same one of the time-division multiplexing circuits are connected to a same one of data lines of a data driving circuit.

4. The display panel according to claim 3, wherein the m switching transistors are respectively connected to m control signal lines, wherein one of the data lines of the data driving circuit provides a data signal to an m-th switching transistor connected to an m-th control signal line when the m-th control signal line is turned on.

5. The display panel according to claim 4, wherein in the first time-division multiplexing circuit, the m-th switching transistor is the dummy switching transistor, and the m-th control signal line provides a dummy start signal to the dummy switching transistor, to enable a corresponding one of the data lines to provide a dummy data signal.

6. The display panel according to claim 4, wherein the pixel island comprises two pixel groups being an odd-numbered pixel group and an even-numbered pixel group, the odd-numbered pixel group comprises odd-numbered columns of pixel units, and the even-numbered pixel group comprises even-numbered columns of pixel units; and
the time-division multiplexing circuit comprise a first switching transistor and a second switching transistor, the first switching transistor is connected to an odd-numbered column of pixel units, and the second switching transistor is connected to an even-numbered column of pixel units adjacent to the odd-numbered column of pixel units.

7. The display panel according to claim 6, further comprising a data driving circuit, wherein the data driving circuit comprises a plurality of data lines, and each of the data lines is used to provide a data signal to the m switching transistors in the time-division multiplexing circuit.

8. The display panel according to claim 7, wherein in each of the time-division multiplexing circuits, the first switching transistor is configured to receive a first data signal, and the second switching transistor is configured to receive a second data signal;
the plurality of pixel islands comprises a first pixel island and a second pixel island adjacent to each other, a pixel unit adjacent to the first pixel island and the second pixel island is the dummy pixel unit, and a data signal received by a pixel unit in the first pixel island adjacent to the dummy pixel unit is the first data signal; and
a data signal received by a pixel unit in the second pixel island adjacent to the dummy pixel unit is the second data signal.

9. The display panel according to claim 1, wherein each of the pixel units comprises a red sub-pixel, a green sub-pixel and a blue sub-pixel.

10. A display device, comprising the display panel according to claim 1, wherein the display panel is connected to a first circuit board through a chip on film technique, the first circuit board is connected to a second circuit board through a flexible circuit board, and the second circuit board is provided with a display interface.

11. A driving method, applied to the display device according to claim 10, comprising:
providing a first control signal through a first control signal line, and controlling a switching transistor at a first position in the N time-division multiplexing circuits to be turned on to transmit a data signal to a corresponding one of the pixel units; and
providing a second control signal through a second control signal line, and controlling a switching transistor at a second position in the N time-division multiplexing circuits to be turned on to transmit a data signal to a corresponding one of the pixel units, wherein the dummy switching transistor in the first time-division multiplexing circuit is configured to receive a dummy data signal.

12. The driving method according to claim 11, wherein the display panel comprises a first pixel island and a second pixel island adjacent to each other, each of the time-division multiplexing circuits comprises two switching transistors, and the driving method comprises:
providing the first control signal through the first control signal line, receiving a first data signal by a first switching transistor in the N time-division multiplexing circuits in the first pixel island, and receiving a second data signal by a third switching transistor in the N time-division multiplexing circuits in the second pixel island, wherein the first switching transistor is connected to one of the pixel units away from the second pixel island in a first direction, the third switching transistor is connected to one of the pixel units close to the first pixel island in the first direction, and the first direction is parallel to a row direction of the pixel units; and
providing the second control signal through the second control signal line, receiving the second data signal by a second switching transistor in the N time-division multiplexing circuits in the first pixel island, and receiving the first data signal by a fourth switching transistor in the N time-division multiplexing circuits in the second pixel island, wherein the second switching transistor is connected to one of the pixel units close to the second pixel island in the first direction, and the fourth switching transistor is connected to one of the pixel units away from the first pixel island in the first direction; wherein the dummy switching transistor in the first time-division multiplexing circuit corresponding to the first pixel island is configured to receive the dummy data signal, and a dummy switching transistor in the first time-division multiplexing circuit corresponding to the second pixel island is configured to receive the dummy data signal.
